(19) United States
(12) Patent Application Publication
(10) Pub. No.: US 2022/0148302 A1
(43) Pub. Date: May 12, 2022

(54) METHOD FOR VISUAL LOCALIZATION AND RELATED APPARATUS

(71) Applicant: Zhejiang SenseTime Technology Development Co., Ltd., Hangzhou (CN)

(72) Inventors: Hujun BAO, Hangzhou (CN); Guofeng ZHANG, Hangzhou (CN); Hailin YU, Hangzhou (CN); Zhichao YE, Hangzhou (CN); Chongshan SHENG, Hangzhou (CN)

(21) Appl. No.: 17/585,114

(22) Filed: Jan. 26, 2022

Related U.S. Application Data
(63) Continuation of application No. PCT/CN2019/117224, filed on Nov. 11, 2019.

(30) Foreign Application Priority Data
Aug. 30, 2019 (CN) 201910821911.3

(51) Int. Cl. G06V 10/86; G06V 10/74; G06V 10/36; G06V 10/77; G06V 10/75; G06V 10/762; G06T 7/70

(52) U.S. Cl. CPC G06V 10/86; G06V 10/761; G06V 10/36; G06T 7/70; G06V 10/751; G06V 10/752; G06V 10/7625; G06V 10/7715

(57) ABSTRACT

Visual localization method and related apparatus are disclosed. In the method, a first candidate image sequence is determined from image library, the image library being configured to construct electronic map, image frames in the first candidate image sequence being sequentially arranged according to degrees of matching with first image, and the first image being an image collected by a camera; an order of the image frames in the first candidate image sequence is adjusted according to target window to obtain second candidate image sequence, the target window being multiple successive image frames including target image frame and determined from the image library, the target image frame being an image matching with second image, which is collected by the camera before the first image is collected, in the image library; and target posture of the camera when the first image is collected is determined according to the second candidate image sequence.

### CROSS-REFERENCE TO RELATED APPLICATION

The application is a continuation application of International Patent Application No. PCT/CN2019/117224, filed on Nov. 11, 2019, which is filed based upon and claims priority to Chinese Patent Application No. 201910821911.3, filed on Aug. 30, 2019. The disclosures of International Patent Application No. PCT/CN2019/117224 and Chinese Patent Application No. 201910821911.3 are hereby incorporated by reference in their entireties.

### BACKGROUND

Localization technologies play an important role in people's daily life. When a Global Positioning System (GPS) is used for localization, it is mostly applied to outdoor localization. At present, indoor localization systems are mainly implemented based on Wireless Fidelity (Wi-Fi) signals, Bluetooth signals, Ultra Wide Band (UWB) and so on. For the localization based on the Wi-Fi signals, it is needed to dispose a large number of wireless Access Points (APs) in advance.

It is simple and convenient to acquire visual information without improvements on scenarios, and surrounding rich visual information can be acquired by using a mobile phone and other devices for photographing images. In visual localization technologies, visual information (images or videos) collected by image or video collection devices such as the mobile phones is used for the localization.

### SUMMARY

The present disclosure relates, but is not limited, to the field of computer vision, and more particularly, to a method for visual localization and a related apparatus.

According to a first aspect, the embodiments of the present disclosure provide a method for visual localization, which may include that: a first candidate image sequence is determined from an image library, the image library being configured to construct an electronic map, image frames in the first candidate image sequence being sequentially arranged according to degrees of matching with a first image, and the first image being an image collected by a camera; an order of the image frames in the first candidate image sequence is adjusted according to a target window to obtain a second candidate image sequence, the target window being multiple successive image frames including a target image frame and determined from the image library, the target image frame being an image matching with a second image in the image library, and the second image being an image collected by the camera before the first image is collected; and a target posture of the camera when the first image is collected is determined according to the second candidate image sequence.

In the embodiments of the present disclosure, with the continuity of the image frames on the time sequence, the localization speed for the successive frames are effectively improved.

In some embodiments, the operation that the target posture of the camera when the first image is collected is determined according to the second candidate image sequence may include that: a first posture of the camera is determined according to a first image sequence and the first image, the first image sequence including multiple successive image frames neighboring to a first reference image frame in the image library, the first reference image frame being included in the second candidate sequence, and the first reference image frame being included in the second candidate image sequence; and in a case where it is determined that a position of the camera is successfully localized according to the first posture, the first posture is determined as the target posture.

In some embodiments, after the first posture of the camera is determined according to the first image sequence and the first image, the method may further include that: in a case where it is determined that the position of the camera is not successfully localized according to the first posture, a second posture of the camera is determined according to a second image sequence and the first image, the second image sequence including multiple successive image frames neighboring to a second reference image frame in the image library, and the second reference image frame being a next image frame or a previous image frame of the first reference image frame in the second candidate image sequence; and in a case where it is determined that the position of the camera is successfully localized according to the second posture, the second posture is determined as the target posture.

In some embodiments, the operation that the first posture of the camera is determined according to the first image sequence and the first image may include that: from features extracted from each image in the first image sequence, F features matching with features extracted from the first image are determined, the F being an integer greater than 0; and the first posture is determined according to the F features, spatial coordinates corresponding to the F features in a point cloud map and internal parameters of the camera, the point cloud map being an electronic map of a to-be-localized scenario, and the to-be-localized scenario being a scenario of the camera when the first image is collected.

In some embodiments, the operation that the order of the image frames in the first candidate image sequence is adjusted according to the target window to obtain the second candidate image sequence may include that: in a case where the image frames in the first candidate image sequence are sequentially arranged according to the degrees of matching with the first image from low to high, an image located in the target window in the first candidate image sequence is adjusted to a last position of the first candidate image sequence; and in a case where the image frames in the first candidate image sequence are sequentially arranged according to the degrees of matching with the first image from high to low, an image located in the target window in the first candidate image sequence is adjusted to a most front position of the first candidate image sequence.

In some embodiments, the operation that the first candidate image sequence is determined from the image library may include the following operations.

Multiple candidate images of which corresponding visual word vectors have a highest similarity with a visual word vector corresponding to the first image in the image library are determined, any image in the image library corresponding to one visual word vector, and images in the image library being configured to construct an electronic map of a to-be-localized scenario of a target device when the first image is collected.

The multiple candidate images are respectively subjected to feature matching with the first image to obtain the number of features matching with the first image in each candidate image.

M images having the largest number of features matching with the first image are acquired from the multiple candidate images to obtain the first candidate image sequence.

In some embodiment, the operation that the multiple candidate images of which the corresponding visual word vectors have the highest similarity with the visual word vector corresponding to the first image in the image library are determined may include that: images corresponding to at least one same visual word with the first image in the image library are determined to obtain multiple primary images, any image in the image library corresponding to at least one visual word, and the first image corresponding to at least one visual word; and multiple candidate images of which corresponding visual word vectors have a highest similarity with the visual word vector of the first image in the multiple primary images are determined.

In some embodiments, the operation that the multiple candidate images of which the corresponding visual word vectors have the highest similarity with the visual word vector of the first image in the multiple primary images are determined may include that: top Q % of images of which corresponding visual word vectors have a highest similarity with the visual word vector of the first image in the multiple primary images are determined to obtain the multiple candidate images, the Q being a real number greater than 0.

In some embodiments, the operation that the multiple candidate images of which the corresponding visual word vectors have the highest similarity with the visual word vector of the first image in the multiple primary images are determined may include the following operations.

The features extracted from the first image are converted into a target word vector by using a vocabulary tree, the vocabulary tree being obtained by clustering features extracted from training images collected from the to-be-localized scenario.

A similarity between the target word vector and a visual word vector corresponding to each primary image in the multiple primary images is calculated, the visual word vector corresponding to any primary image in the multiple primary images being a visual word vector obtained, by using the vocabulary tree, from features extracted from the primary image.

Multiple candidate images of which corresponding visual word vectors have a highest similarity with the target visual word vector in the multiple primary images are determined.

In the implementation, the features extracted from the first image are converted into the target word vector by using the vocabulary tree, and the similarity between the target word vector and the visual word vector corresponding to each primary images is calculated to obtain the multiple candidate images; and therefore, the candidate images may be screened quickly and accurately.

In some embodiments, each leaf node in the vocabulary tree corresponds to one visual word, and nodes on a last layer of the vocabulary tree are leaf nodes; and the operation that the features extracted from the first image are converted into the target word vector by using the vocabulary tree may include the following operations.

Corresponding weights of visual words corresponding to leaf nodes in the vocabulary tree in the first image are calculated.

The corresponding weights of the visual words corresponding to the leaf nodes in the first image are combined into a vector to obtain the target word vector.

In the implementation, the target word vector may be quickly calculated.

In some embodiments, each node in the vocabulary tree corresponds to one clustering center; and the operation that the corresponding weights of the visual words corresponding to the vocabulary tree in the first image are calculated may include the following operations.

The features extracted from the first image are classified by using the vocabulary tree to obtain intermediate features classified to a target leaf node, the target leaf node being any leaf node in the vocabulary tree, and the target leaf node corresponding to a target visual word.

A corresponding target weight of the target visual word in the first image is calculated according to the intermediate features, a weight of the target visual word and a clustering center corresponding to the target visual word, the target weight being positively correlated with the weight of the target visual word, and the weight of the target visual word being determined according to the number of corresponding features of the target visual word when the vocabulary tree is generated.

In some embodiments, the intermediate features include at least one sub-feature; the target weight is a sum of weight parameters corresponding to sub-features included in the intermediate features; and the weight parameters corresponding to the sub-features are negatively correlated with a feature distance, and the feature distance is a Hamming distance between each sub-feature and a corresponding clustering center.

In the implementation, the considerations are given to differences between the features in the same visual word.

In some embodiments, the operation that the multiple candidate images are respectively subjected to the feature matching with the first image to obtain the number of features matching with the first image in each candidate image may include the following operations.

A third feature extracted from the first image is classified to a leaf node according to the vocabulary tree, the vocabulary tree being obtained by clustering features extracted from images collected in the to-be-localized scenario, nodes on a last layer of the vocabulary tree being leaf nodes, and each leaf node including multiple features.

The feature matching is performed on the third feature and a fourth feature in each leaf node, to obtain the fourth feature matching with the third feature in each leaf node, the fourth feature being a feature extracted from a target candidate image, and the target candidate image being included in any image in the first candidate image sequence.

According to the fourth feature matching with the third feature in each leaf node, the number of features matching with the first image in the target candidate image is obtained.

With such a manner, the computation burden of the feature matching may be reduced, and the speed of the feature matching is greatly improved.

In some embodiments, after the first posture is determined according to the F features, the spatial coordinates corresponding to the F features in the point cloud map and the internal parameters of the camera, the method may further include the following operation.

A Three-Dimensional (3D) position of the camera is determined according a conversion matrix and the first posture, the conversion matrix being obtained by converting an angle and a position of the point cloud map, and aligning a contour of the point cloud map to an interior plan.

In some embodiments, the case where it is determined that the position of the camera is successfully localized by the first posture includes: it is determined that position relationships for L pairs of feature points meet the first posture, each pair of feature points including one feature point extracted from the first image and the other feature point extracted from an image in the first image sequence, and the L being an integer greater than 1.

In the implementation, whether a position of a target device can be successfully localized by the second posture may be determined quickly and quickly.

In some embodiments, before the first posture of the camera is determined according to the first image sequence and the first image, the method may further include the following operations.

Multiple image sequences are acquired, each image sequence being obtained by collecting one region or multiple regions in a to-be-localized scenario.

The point cloud map is constructed according to the multiple image sequences, any image sequence in the multiple image sequences being configured to construct a sub-point cloud map for one or more regions, and the point cloud map including a first electronic map and a second electronic map.

In the implementation, the to-be-localized scenario is divided into multiple regions to construct the sub-point cloud maps. In this way, when some region in the to-be-localized scenario changes, only a video sequence of the region needs to be collected to construct the sub-point cloud map for the region, and the point cloud map for the whole to-be-localized scenario is unnecessarily constructed; and thus, the workload may be effectively reduced.

In some embodiments, before the features extracted from the first image are converted into the target word vector by using the vocabulary tree, the method may further include the following operations.

Multiple training images obtained by photographing the to-be-localized scenario are acquired.

Feature extraction is performed on the multiple training images to obtain a training feature set.

Features in the training feature set are clustered for multiple times to obtain the vocabulary tree.

In some embodiments, the method for visual localization is applied to a server, and before the first candidate image sequence is determined from the image library, the method may further include that: the first image from the target device is received, the target device being provided with the camera.

In the implementation, the server performs the localization according to the first image from the target device, such that advantages of the service in processing speed and storage space may be fully utilized, and thus the localization accuracy is high and the localization speed is fast.

In some embodiments, after the case where the position of the target device is successfully localized by the second posture is determined, the method may further include that: position information of the camera is sent to the target device.

In the implementation, the server sends the position information of the target device to the target device, such that the target device displays the position information, and a user may accurately know where the target device is located.

In some embodiments, the method for visual localization is applied to an electronic device provided with the camera.

According to a second aspect, the embodiments of the disclosure provide another method for visual localization, which may include the following operations: a target image is collected by a camera.

Target information is sent to a server, the target information including the target image or a feature sequence extracted from the target image, and internal parameters of the camera.

Position information is received, wherein the position information is configured to indicate a position and a direction of the camera; the position information is information of a position, determined by the server according to a second candidate image sequence, of the camera when the target image is collected; and the second candidate image sequence is obtained by the server through adjusting an order of image frames in a first candidate image sequence according to a target window, the target window is multiple successive image frames including a target image frame and determined from an image library, the image library is configured to construct an electronic map, the target image frame is an image matching with a second image in the image library, the second image is an image collected by the camera before the first image is collected, and the image frames in the first candidate image sequence are sequentially arranged according to degrees of matching with the first image.

An electronic map is displayed, the electronic map including the position and the direction of the camera.

According to a third aspect, the embodiments of the disclosure provide an apparatus for visual localization, which may include: a screening unit and a determination unit.

The screening unit is configured to determine a first candidate image sequence from an image library, the image library being configured to construct an electronic map, image frames in the first candidate image sequence being sequentially arranged according to degrees of matching with a first image, and the first image being an image collected by a camera.

The screening unit is further configured to adjust an order of the image frames in the first candidate image sequence according to a target window to obtain a second candidate image sequence, the target window being multiple successive image frames including a target image frame and determined from the image library, the target image frame being an image matching with a second image in the image library, and the second image being an image collected by the camera before the first image is collected.

The determination unit is configured to determine, according to the second candidate image sequence, a target posture of the camera when the first image is collected.

According to a fourth aspect, the embodiments of the disclosure provide a terminal, which may include: a camera, a sending unit, a receiving unit and a display unit.

The camera is configured to collect a target image.

The sending unit is configured to send target information to a server, the target information including the target image or a feature sequence extracted from the target image, and internal parameters of the camera.

The receiving unit is configured to receive position information, wherein the position information is configured to indicate a position and a direction of the camera; the position information is information of a position, determined by the server according to a second candidate image sequence, of the camera when the target image is collected; and the second candidate image sequence is obtained by the server through adjusting an order of image frames in a first candidate image sequence according to a target window, the target window is multiple successive image frames including a target image frame and determined from an image library, the image library is configured to construct an electronic map, the target image frame is an image matching with a second image in the image library, the second image is an image collected by the camera before the first image is collected, and the image frames in the first candidate image sequence are sequentially arranged according to degrees of matching with the first image.

The display unit is configured to display an electronic map, the electronic map including the position and the direction of the camera.

According to a fifth aspect, the embodiments of the disclosure provide an electronic device, which may include: a memory, configured to store a program; and a processor, configured to execute the program stored in the memory; and when the program is executed, the processor is configured to execute the method in the first aspect, the second aspect and any implementation.

According to a sixth aspect, the embodiments of the disclosure provide a terminal device, comprising: a camera, configured to collect a target image; a transceiver, configured to send target information to a server, the target information comprising the target image or a feature sequence extracted from the target image, and internal parameters of the camera; receive position information, wherein the position information is configured to indicate a position and a direction of the camera; the position information is information of a position, determined by the server according to a second candidate image sequence, of the camera when the target image is collected; and the second candidate image sequence is obtained by the server through adjusting an order of image frames in a first candidate image sequence according to a target window, the target window is multiple successive image frames comprising a target image frame and determined from an image library, the image library is configured to construct an electronic map, the target image frame is an image matching with a second image in the image library, the second image is an image collected by the camera before the first image is collected, and the image frames in the first candidate image sequence are sequentially arranged according to degrees of matching with the first image; and a display, configured to display an electronic map, the electronic map comprising the position and the direction of the camera.

According to a seventh aspect, the embodiments of the disclosure provide a visual localization system, which may include: a server and a terminal device; the server executes the method in the first aspect and any implementation; and the terminal device is configured to execute the method in the second aspect.

According to an eighth aspect of the embodiments of the present disclosure provide a computer-readable storage medium; the computer storage medium stores a computer program; the computer program includes a program instruction; and the program instruction is executed by a processor to cause the processor to execute the method in the first aspect, second aspect and any implementation.

According to a ninth aspect of the embodiments of the present disclosure provide a computer program product; the computer program product includes a program instruction; and the program instruction is executed by a processor to cause the processor to execute the method for visual localization provided by the foregoing any embodiment.

### BRIEF DESCRIPTION OF THE DRAWINGS

In order to describe the technical solutions in the embodiments of the present disclosure more clearly, descriptions on the accompanying drawings which are needed in the embodiments or background of the present disclosure are given below.

FIG. 1 illustrates a schematic diagram of a vocabulary tree provided by an embodiment of the present disclosure.

FIG. 2 illustrates a method for visual localization provided by an embodiment of the present disclosure.

FIG. 3 illustrates another method for visual localization provided by an embodiment of the present disclosure.

FIG. 4 illustrates still another method for visual localization provided by an embodiment of the present disclosure.

FIG. 5 is a localization navigating method provided by an embodiment of the present disclosure.

FIG. 6 illustrates a method for constructing a point cloud map provided by an embodiment of the present disclosure.

FIG. 7 illustrates a structural schematic diagram of an apparatus for visual localization provided by an embodiment of the present disclosure.

FIG. 8 illustrates a structural schematic diagram of a terminal provided by an embodiment of the present disclosure.

FIG. 9 illustrates a structural schematic diagram of another terminal provided by an embodiment of the present disclosure.

FIG. 10 illustrates a structural schematic diagram of a server provided by an embodiment of the present disclosure.

### DETAILED DESCRIPTION

To make those skilled in the art better understand the solutions in the embodiments of the present disclosure, the following clearly describes the technical solutions in the embodiments of the present disclosure in combination with the accompanying drawings in the embodiments of the present disclosure. Apparently, the described embodiments are only a part rather than all of the embodiments of the present disclosure.

The terms such as “first”, “second” and “third” in the embodiments of the specification, claims and accompanying drawings of the present disclosure are only used to distinguish similar objects, rather than to describe a special order or a precedence order. In addition, the terms “comprise,” “comprising,” “include,” “including,” “has,” “having” or any other variation thereof, are intended to cover a non-exclusive inclusion. For example, a method, system, product or device that includes a list of steps or units is not necessarily limited to only those steps or units but may include other steps or units not expressly listed or inherent to such method, product or device.

As non-visual information-based localization methods typically need to dispose devices in to-be-localized scenarios in advance and are not high in localization accuracy, visual information-based localization methods are main research trends at present. The method for visual localization provided by the embodiments of the present disclosure can be applied to scenarios such as position recognition, and position navigation. Single introduction on applications of the method for visual localization provided by the embodiments of the present disclosure in position recognition scenario and position navigation scenario are respectively given below.

Position recognition scenario: with a big shopping mall for example, the shopping mall (i.e., to-be-localized scenario) may be divided into regions; and technologies such as Structure from Motion (SFM) are used for each region to construct a point cloud map of the shopping mall. When the user desires to determine the own position and/or direction in the shopping mall, the user may start a target application on a mobile phone. The mobile phone collects surrounding images by use of a camera, displays an electronic map on the screen, and marks the position and direction where the user is located at present on the electronic map. The target application is an application specifically developed for accurate indoor localization.

Position navigation scenario: with the big shopping mall for example, the shopping mall may be divided into the regions; and the technologies such as the Structure from Motion (SFM) are used for each region to construct the point cloud map of the shopping mall. When the user gets lost or desires to visit some store in the shopping mall, the user starts a target application on the mobile phone, and inputs a destination address to be reached. The user holds up the mobile phone to collect images in front; and the mobile phone displays the collected images in real time, and displays signs, such as arrows, through which the user arrives at the destination address. The target application is an application specifically developed for accurate indoor localization. Due to a very small computational performance of the mobile phone, there is a need to place it on a cloud terminal for computation, i.e., the localization operation is implemented by the cloud terminal. In view of frequent change of the shopping mall, it may be appropriate to only reconstruct the point cloud map for the changed region, and the reconstruction of the point cloud map for the whole shopping mall turns out to be unnecessary.

As the image feature extraction, SFM algorithm, posture estimation and the like are involved in the embodiments of the present disclosure, for the ease of understanding, relevant terms and concepts in the embodiments of the present disclosure are introduced below first.

(1) Feature Point, Descriptor and Oriented Fast and Rotated Brief (ORB) Algorithm

The feature point of the image may be simply understood as a conspicuous point in the image, such as a contour point, a highlight point in the dark region, and a dark point in the bright region. Such a definition is based upon image gray values around the feature point. By detecting pixel values around a candidate feature point, if plenty of pixel points in the surrounding region of the candidate point are quite different from the candidate point in gray value, it is considered that the candidate point is the feature point. Upon the acquisition of the feature point, attributes of the feature point are necessarily described in some manner. Outputs of these attributes are called feature descriptors on the feature point. The ORB algorithm serves as a fast feature point extraction and description algorithm. The ORB algorithm uses the Features from Accelerated Segment Test (FAST) algorithm to detect the feature point. The FAST algorithm is an algorithm for angular point detection. The principle of the algorithm is to take a detection point in the image; and whether the detection point is the angular point is determined by 16 pixel points around the point as a center of a circle. The ORB algorithm uses the BRIEF algorithm to calculate the descriptors on one feature point. The core concept of the BRIEF algorithm is to select N point pairs around the key point P in a certain mode, and combine with comparison results of the N point pairs together to serve as the descriptors.

Fast computation speed is the biggest feature of the ORB algorithm. First, it uses the FAST to detect the feature point. As its name implies, the FAST has the well-known fast detection speed. Then, the BRIEF algorithm is used to compute the descriptors. The special binary string form of the descriptors not only saves the storage space, but also greatly shortens the matching time. For example, the descriptors for the feature points A and B are as follows: A: 10101011; and B: 10101010. A threshold, such as 80%, is set. When the similarity between the descriptors of the A and the B is greater than 90%, it is determined that the A and the B are the same feature point, i.e., the two points match successfully. In this example, the A and the B are only different in last bit; and the similarity is 87.5%, which is greater than 80%. Therefore, the A and the B match.

(2) SFM Algorithm

The SFM algorithm is an offline algorithm for Three-Dimensional (3D) reconstruction based on various collected orderless pictures. Before the core of the SFM algorithm is carried out, some preparations need to be made to select suitable pictures. Focal length information is extracted from the pictures first, then image features are extracted by using feature extraction algorithms such as Scale-Invariant Feature Transform (SIFT), and a kd-tree model is used to calculate the Euclidean distance between feature points of two pictures for feature point matching, thereby finding image pairs of which the number of matching feature points meets the requirement. The SIFT is the algorithm for detecting local features. The kd-tree is derived from the Binary Search Tree (BST) and is a high-dimensional index tree-shaped data structure. The kd-tree is often used in dense search and comparison scenarios of large-scale high-dimensional data, and mainly includes Nearest Neighbor and Approximate Nearest Neighbor. In computer vision, it is mainly applied to search and comparison of high-dimensional feature vectors in image retrieval and recognition. For each image matching pair, the epipolar geometry is calculated, the basis matrix (i.e., F matrix) is estimated, and the matching pair is optimized and improved by a Random Sample Consensus (RANSAC) algorithm. If the feature point may be transferred in a chained manner in such a matching pair and detected all the time, a track may be formed. Then, the SFM is applied, and the first key step is to select good image pairs to initialize the whole Bundle Adjustment (BA) process. First of all, two pictures selected for initialization are subjected to the BA for the first time; then, new pictures are added circularly for new BA; and at last, the BA cannot be ended until no suitable picture is added continuously. Therefore, camera estimation parameters and scenario geographical information, i.e., sparse 3D point cloud (point cloud map), are obtained.

(3) RANSAC Algorithm

The RANSAC algorithm is to iteratively estimate parameters of a mathematical algorithm from a group of observed data including outliers. The basic hypothesis of the RANSAC algorithm is that the samples include correct data (inliers, which are data capable of being described by the model), and also include abnormal data (outliers, which are data far deviated from the normal range and unsuitable for the mathematical model), i.e., the data set includes noise. These abnormal data are possibly due to wrong measurement, wrong hypothesis, wrong calculation, etc. The input of the RANSAC algorithm is a group of observed data, a parameterized model that may explain or be adapted for the observed data, and some credible parameters. The RANSAC achieves the purpose by repeatedly selecting a group of random subsets in the data. The selected subsets are assumed as internal points, and verified in the following method: 1, there is a model adapted for the assumed internal points, i.e., all unknown parameters can be calculated from the assumed internal points. 2. The model obtained in 1 is used to test all other data; and if some point is adapted for the estimated model, it is considered that the point is the internal point. 3. If sufficient points are classified as the assumed internal points, the estimated model is adequately reasonable. 4. Then, all assumed internal points are used to reestimate the model because the model is only estimated by the initial assumed internal points. 5. At last, the model is evaluated by estimating error rates of the internal points and the model. Such a process is repeatedly executed for the fixed number of times; and the model produced each time is either abandoned due to too few internal points, or selected because it is superior to the existing model.

(4) Vocabulary Tree

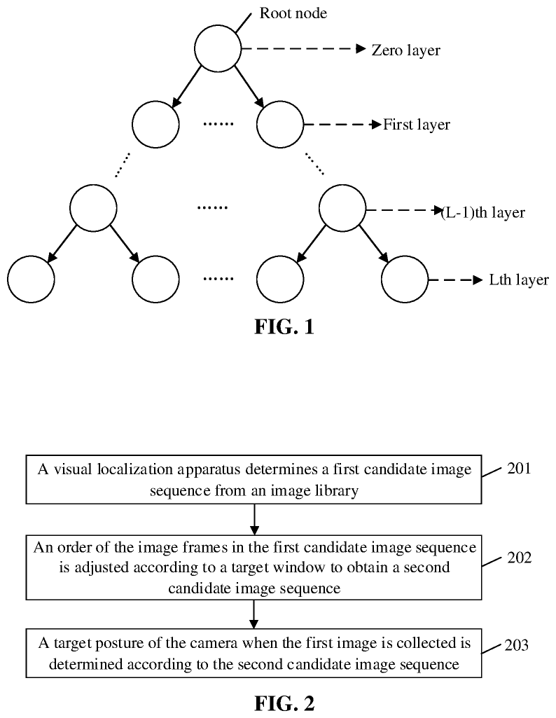

The vocabulary tree is a data structure for efficiently retrieving images based on visual vocabularies (also called visual words). In face of massive image library, one tree structure allows to query keywords within sublinear time rather than to scan all keywords to search the matching images, such that the retrieval speed may be greatly improved. Hereinafter, the introduction on how to construct the vocabulary tree is given: 1. ORB features of all training images are extracted. About 3000 features are extracted for each training image. The training images are collected from a to-be-localized scenario. 2. All extracted features are clustered into K categories by use of the k-mean, each category of features is clustered into K types in the same way till an Lth layer, a clustering center of each layer is kept and finally the vocabulary tree is generated. Both the K and the L are integers greater than 1. For example, the K is 10, and the L is 6. Leaf nodes are nodes on the Lth layer, and are final visual words. Each node in the vocabulary tree serves as one clustering center. FIG. 1 illustrates a schematic diagram of a vocabulary tree provided by an embodiment of the present disclosure. As shown in FIG. 1, the vocabulary tree includes (L+1) layers in total, among which the first layer includes a root node, and the last layer includes multiple leaf nodes.

FIG. 2 illustrates a method for visual localization provided by an embodiment of the present disclosure. As shown in FIG. 2, the method may include the following steps.

In 201, an apparatus for visual localization determines a first candidate image sequence from an image library.

The visual localization apparatus may be a server, and may also be a mobile terminal capable of collecting images such as a mobile phone and a tablet. The image library is configured to construct an electronic map. The first candidate image sequence includes M images, and the image frames in the first candidate image sequence are sequentially arranged according to degrees of matching with a first image. The first image is an image collected by the camera of the target device, and the M is an integer greater than 1. For example, the M is 5, 6 or 8, etc. The target device may be a device capable of collecting images and/or videos such as the mobile phone and the tablet. During implementation, multiple candidate images are selected first by calculating a similarity between visual word vectors, and then M images having the largest number of features matching with the first image are acquired from the multiple candidate images; and therefore, the image retrieval efficiency is high.

In some embodiments, the first image frame in the first candidate image sequence has the largest number of features matching with the first image, and the last image frame in the first candidate image sequence has the least number of features matching with the first image.

In some embodiments, the first image frame in the first candidate image sequence has the least number of features matching with the first image, and the last image frame in the first candidate image sequence has the largest number of features matching with the first image.

In some embodiments, the visual localization apparatus is the server, the first image is the image received from the mobile terminal such as the mobile phone, and the first image may be the image collected by the mobile terminal in the to-be-localized scenario.

In some embodiments, the visual localization apparatus is the mobile terminal capable of collecting the images such as the mobile phone and the tablet, and the first image is the image extracted by the visual localization apparatus in the to-be-localized scenario.

With such a manner, some images may be primarily screened from the image library, and then multiple candidate images of which the corresponding visual word vectors have a highest similarity with the visual word vector of the first image are selected from these images. Therefore, the image retrieval efficiency may be greatly improved.

In 202, an order of the image frames in the first candidate image sequence is adjusted according to a target window to obtain a second candidate image sequence. The target window includes multiple successive image frames including a target image frame and determined from the image library, the target image frame is an image matching with a second image in the image library, and the second image is an image collected by the camera before the first image is collected.

In some embodiments, the operation that the order of the image frames in the first candidate image sequence is adjusted according to the target window to obtain the second candidate image sequence may be implemented as follows: in a case where the image frames in the first candidate image sequence are sequentially arranged according to the degrees of matching with the first image from low to high, an image located in the target window in the first candidate image sequence is adjusted to a last position of the first candidate image sequence; and in a case where the image frames in the first candidate image sequence are sequentially arranged according to the degrees of matching with the first image from high to low, an image located in the target window in the first candidate image sequence is adjusted to a most front position of the first candidate image sequence. The visual localization apparatus may store or be associated with the image library. The images in the image library are configured to construct a point cloud map of the to-be-localized scenario.

In some embodiments, the image library includes one or more image sequences, each image sequence includes multiple successive image frames obtained by collecting one region of the to-be-localized scenario, and each image sequence may be configured to construct one sub-point cloud map, i.e., the point cloud map of one region. These sub-point cloud maps form the point cloud map. It may be understood that the images in the image library may be successive. In actual applications, the to-be-localized scenario may be divided into regions, image sequences of multiple perspectives are collected for each region, and image sequences in forward and backward directions are at least needed for each region.

The target window may be an image sequence including the target image frame, and may also be a part of the image sequence including the target image frame. For example, the target window includes 61 image frames, i.e., the target image frame and 30 image frames in front and rear of the target image frame. In the embodiment of the present disclosure, there are no limits made on the size of the target window. Supposing that images in the first candidate image sequence are the image 1, image 2, image 3, image 4 and image 5 sequentially, the image 3 and image 5 being calibrated images, the images in the second candidate image sequence are the image 3, image 5, image 1, image 2 and image 4 sequentially. It may be understood that the method in FIG. 2 is to implement the localization on successive frames. The visual localization apparatus may implement the localization on single frame by executing the step 201, step 203, step 204 and step 205.

In 203, a target posture of the camera when the first image is collected is determined according to the second candidate image sequence.

The target posture herein may at least include a position of the camera when the first image is collected. In other some embodiments, the target posture may include: the position and the pose of the camera when the first image is collected. The pose of the camera includes but not limited to an orientation of the camera.

In some embodiments, the operation that the target posture of the camera when the first image is collected is determined according to the second candidate image sequence may be implemented as follows: a first posture of the camera is determined according to a first image sequence and the first image, the first image sequence including multiple successive image frames neighboring to a first reference image frame in the image library, and the first reference image frame being included in the second candidate sequence. In a case where it is determined that the position of the camera is successfully localized according to the first posture, the first posture is determined as the target posture. In a case where it is determined that the position of the camera is not successfully localized according to the first posture, a second posture of the camera is determined according to a second image sequence and the first image. The second image sequence includes multiple successive image frames neighboring to a second reference image frame in the image library, and the second reference image frame is a next image frame or a previous image frame of the first reference image frame in the second candidate image sequence.

In some embodiments, the first image sequence includes front K1 image frames for the first reference image frame, the first reference image frame, and rear K1 image frames for the first reference image frame. The K1 is an integer greater than 1, for example, the K1 is 10.

In some embodiments, the operation that the first posture of the camera is determined according to the first image sequence and the first image may be as follows: from features extracted from each image in the first image sequence, F features matching with features extracted from the first image are determined, the F being an integer greater than 0; and the first posture is determined according to the F features, spatial coordinates corresponding to the F features in a point cloud map and internal parameters of the camera. The point cloud map is an electronic map of the to-be-localized scenario, and the to-be-localized scenario is a scenario of the camera when the first image is collected. The to-be-localized scenario is a scenario of the target device when the first image is collected.

For example, the visual localization apparatus may determine the first posture of the camera by using a Perspective-n-Point (PnP) algorithm according to the F features, the spatial coordinates corresponding to the F features in the point cloud map and the internal parameters of the camera. Each feature in the F features corresponds to one feature point in the image. That is, each feature corresponds to one Two-Dimensional (2D) reference point (i.e., a 2D coordinate of the feature point in the image). By matching the 2D reference point with the spatial coordinate point (i.e., the 3D reference point), the spatial coordinate point corresponding to each 2D reference point may be determined, and thus the one-to-one corresponding relationship between the 2D reference point and the spatial coordinate point may be known. As each feature corresponds to one 2D reference point, and each 2D reference point matches with one spatial coordinate point, the spatial coordinate point corresponding to each feature may be known. The visual localization apparatus may also use other manners to determine the corresponding spatial coordinate point of each feature in the point cloud map, and there are no limits made thereto in the present disclosure. The corresponding spatial coordinates of the F features in the point cloud map are 3D reference points (spatial coordinates) in F world coordinate systems. The PnP is a method for solving the movement of the point pair from 3D to 2D, i.e., how to solve the posture of the camera when F 3D spatial points are given. The known conditions of the PnP problem are: coordinates of 3D reference points in the F world coordinate systems, the F being an integer greater than 0; coordinates of 2D reference points corresponding to the F 3D points and projected onto the image; and the internal parameters of the camera. By solving the PnP problem, the posture of the camera (which may also be a camera) may be obtained. There are a variety of typical ways to solve the PnP problems, such as P3P, Direct Linear Transform (DLP), Efficient PnP (EPnP), UPnP, and a nonlinear optimization method. Therefore, the visual localization apparatus may use any way to solve the PnP problem, and determine the second posture of the camera according to the F features, the spatial coordinates corresponding to the F features in the point cloud map and the internal parameters of the camera. In addition, in view of the feature mismatching situation, the Ransac algorithm may be used herein for iteration, and the number of internal points is counted in each round of iteration. When the number of internal points meets some proportion or the iteration is performed for the fixed number of rounds, the iteration is ended, and the solution (R and t) having the largest number of internal points is returned. The R is the rotation matrix, and the t is the translation vector, i.e., the posture of the camera includes two parameters. In the embodiment of the present disclosure, the camera is equivalent to the camera and another image or video collection apparatus.

According to the method for localizing the successive frames provided by the embodiment of the present disclosure, the image of the first posture of the camera is localized by using the frame before the first image to adjust the order of each image in the first candidate image sequence, such that the continuity of the images on time sequence can be fully utilized, and the images which are most possible to match with the first image are arranged in the most front of the first candidate image sequence; and therefore, the images matching with the first image may be searched more quickly.

In some embodiments, after executing step 203, the visual localization apparatus may further execute the following operation to determine a 3D position of the camera: the 3D position of the camera is determined according a conversion matrix and the first posture. The conversion matrix is obtained by converting an angle and a position of the point cloud map, and aligning a contour of the point cloud map to an interior plan. Specifically, the rotation matrix R and the translation vector t are spliced into a 4*4

$${matrixT}^{′} = [ \begin{matrix}R & t \\ {0}^{T} & 1\end{matrix} ] ,$$

the conversion matrix Tᵢ is left multiplied with the matrix T′ to obtain a new matrix T=Tᵢ⁻¹*T′, the T is expressed as

$$T = [ \begin{matrix}{R}_{3 * 3}^{*} & {t}^{*} \\ {0}^{T} & 1\end{matrix} ] ,$$

and the t* is the final 3D position of the camera. In the implementation, the 3D position of the camera may be accurately determined, and thus the implementation is simple.

According to the method for localizing the successive frames provided by the embodiment of the present disclosure, the image of the first posture of the camera is localized by using the frame before the first image to adjust the order of each image in the first candidate image sequence, such that the continuity of the images on time sequence can be fully utilized, and the images which are most possible to match with the first image are arranged in the most front of the first candidate image sequence; and therefore, the images matching with the first image may be searched more quickly and localized quickly.

In an implementation, the case where the position of the camera is successfully localized by the first posture may be: it is determined that position relationships for L pairs of feature points meet the first posture, each pair of feature points including one feature point extracted from the first image and the other feature point extracted from an image in the first image sequence, and the L being an integer greater than 1. Exemplarily, the PnP is solved iteratively by using the Ransac algorithm according to the first posture, and the number of internal points is counted in each round of iteration. When the number of internal points is greater than a target threshold (such as 12), it is determined that the position of the camera is successfully localized by the first posture; and when the number of internal points is not greater than the target threshold (such as 12), the position of the camera is not successfully localized by the first posture. In actual applications, if the position of the camera is not successfully localized by some image frame in the second candidate image sequence, the visual localization apparatus uses a next image frame for the image frame in the second candidate image sequence for localization.

If the position of the camera cannot be successfully localized by each image frame in the second candidate image sequence, a localization failure is returned. According to the method for localizing the successive frames provided by the embodiment of the present disclosure, after the position of the camera is successfully localized by the first image, a next image frame collected by the camera for the first image is successively used for localization.

In actual applications, the visual localization apparatus may sequentially use each image frame according to a chronological order for each image frame in the second candidate sequence to localize the position of the camera, till the position of the camera is localized. If the position of the camera cannot be successfully localized by each image frame in the second candidate image sequence, a localization failure is returned. For example, the visual localization apparatus first uses the first image frame in the second candidate image sequence for localization, and if the localization is successful, the localization at this time is ended; and if the localization is not successful, the second image frame in the second candidate image sequence is used for localization, and so on. The method for localizing the target posture of the camera by using the image sequence and the first image sequence at different times may be the same.

The introduction on how to determine the first candidate image sequence from the image library, i.e., the implementation of step 201, is given below.

In an implementation, the manner for determining the first candidate image sequence from the image library may be as follows: the features extracted from the first image are converted into a target word vector by using a vocabulary tree; a similarity score between the target word vector and a word vector corresponding to each image in the image library is calculated; top 10 image frames having highest similarity scores with the first image in each image sequence included in the image library are acquired to obtain a primary image sequence; after each image in the primary image sequence is sorted according to a sequence of the similarity scores from high to low, top 20% images are taken out to serve as an intermediate image sequence, if there are less than 10 frames, top 10 frames being directly taken; feature matching is performed on each image frame in the intermediate image sequence and the first image; and after each image frame in the intermediate image sequence is sorted according to the number of features matching with the first image from most to least, top M images are selected to obtain the first candidate image sequence.

In an implementation, the manner for determining the first candidate image sequence from the image library may be as follows: multiple candidate images of which corresponding visual word vectors have a highest similarity (i.e., the similarity score) with a visual word vector corresponding to the first image in the image library are determined; the multiple candidate images are respectively subjected to feature matching with the first image to obtain the number of features matching with the first image in each candidate image; and M images having the largest number of features matching with the first image in the multiple candidate images are acquired to obtain the first candidate image sequence.

In some embodiments, the M is 5. Any image in the image library corresponds to one visual word vector, and images in the image library is configured to construct an electronic map of a to-be-localized scenario of the target device when the first image is collected.

In some embodiments, the operation that the multiple candidate images of which the corresponding visual word vectors have the highest similarity with the visual word vector of the first image in the image library may be as follows: images corresponding to at least one same visual word with the first image in the image library are determined to obtain multiple primary images; and top Q % of images of which corresponding visual word vectors have a highest similarity with the visual word vector of the first image in the multiple primary images are determined to obtain the multiple candidate images, the Q being a real number greater than 0. For example, the Q is 10, 15, 20, 30, etc. Any image in the image library corresponds to at least one visual word, and the first image corresponds to at least one visual word.

In some embodiments, the visual localization apparatus obtains the multiple candidate images in the following manner: the features extracted from the first image are converted into a target word vector by using a vocabulary tree; a similarity between the target word vector and a visual word vector corresponding to each primary image in the multiple primary images is calculated; and top Q % of images of which corresponding visual word vectors have a highest similarity with the target word vector in the multiple primary images are determined to obtain the multiple candidate images. The vocabulary tree is obtained by clustering features extracted from training images collected from the to-be-localized scenario. The visual word vector corresponding to any primary image in the multiple primary images is a visual word vector obtained from features extracted from the primary image by the use of the vocabulary tree.

In some embodiments, the operation that the multiple candidate images are respectively subjected to the feature matching with the first image to obtain the number of features matching with the first image in each candidate image may be as follows: a third feature extracted from the first image is classified to a reference leaf node according to the vocabulary tree; and the feature matching is performed on the third feature and a fourth feature to obtain features matching with the third feature. The vocabulary tree is obtained by clustering features extracted from images collected in the to-be-localized scenario; and nodes on a last layer of the vocabulary tree are leaf nodes, and each leaf node includes multiple features. The fourth feature is included in the reference leaf node and is the feature extracted from the target candidate image. The target candidate image is included in the first candidate image sequence. It may be understood that if some feature extracted from the first image corresponds to the reference leaf node (any leaf node in the vocabulary tree), when the visual localization apparatus performs the feature matching on the feature and a feature extracted from some candidate image, the feature matching is only performed on the feature and the feature corresponding to the reference leaf node in the features extracted from the candidate image, and the feature matching on the feature and other features turns out to be unnecessary.

The visual localization apparatus may pre-store an image index and a feature index that correspond to each visual word (i.e., the leaf node). In some embodiments, corresponding image index and feature index are added to each visual word, and these indexes are used to accelerate the feature matching. For example, in a case where 100 images in the image library correspond to some visual word, an index (i.e., the image index) for the 100 images and an index (i.e., the feature index) for the features of leaf nodes corresponding to the 100 images in the visual word are added to the visual word. Also for example, when the reference feature extracted from the first image falls onto the reference node, when the feature matching is performed on the reference feature and the features extracted from the multiple candidate images, target candidate images indicated by an image index of the reference node in the multiple candidate images are first determined, the feature that the target candidate image falls onto the reference node is determined according to the feature index, and the matching is performed on the reference feature and the feature that the target candidate image falls onto the reference node. With such a manner, the computation burden of the feature matching may be reduced, and the speed of the feature matching is greatly improved.

The manner on how to convert the features extracted from the first image into the target word vector by using the vocabulary tree is described below.

The operation that the features extracted from the first image are converted into the target word vector by using the vocabulary tree may include that: a corresponding target weight of the target visual word in the first image is calculated according to the features extracted from the first image, a weight of the target visual word and a clustering center corresponding to the target visual word, the target word vector including corresponding weights of visual words corresponding to the vocabulary tree in the first image, and the target weight being positively correlated with the weight of the target visual word. In the implementation, the word vector is calculated by using a residual weighting manner. In view of differences of features fallen into the same visual word, the discrimination is increased, such that the access to a Term frequency-Inverse Document Frequency (TF-IDF) frame is very easy, and thus the speed for image retrieval and feature matching can be improved.

In some embodiments, the features extracted from the first image are converted into the target word vector by using the vocabulary tree in the following formula:

$${W}_{i} = {\sum }_{j}^{n} {W}_{iweight} * [ 1 - \frac{D i s ( {f}_{i} * {c}_{i} )}{256} ] . \qquad ( 1 )$$

Where, the W_{weight} is a weight of the ith visual word, the Dis(fᵢ,cᵢ) is a Hamming distance from the feature fᵢ to the clustering center cᵢ of the ith visual word, the n denotes the number of features fallen onto a node corresponding to the ith visual word in the features extracted from the first image, and the Wᵢ denotes a corresponding weight of the ith visual word on the first image. Each leaf node in the vocabulary tree corresponds to one visual word, and the target word vector includes corresponding weights of the visual words corresponding to the vocabulary tree in the first image. Each node in the vocabulary tree corresponds to one clustering center. For example, the vocabulary tree includes 1000 leaf nodes, each leaf node corresponds to one visual word, and the visual localization apparatus needs to calculate a corresponding weight of each visual word in the first image to obtain the target word vector of the first image. In some embodiments, the visual localization apparatus may calculate corresponding weights of visual words corresponding to leaf nodes in the vocabulary tree in the first image; and combine the corresponding weights of the visual words corresponding to the leaf nodes in the first image into a vector to obtain the target word vector. It may be understood that the same manner may be used to calculate corresponding word vectors of the images in the image library to obtain the visual word vector corresponding to each primary image. Both the i and the n are integers greater than 1. The feature fᵢ is any feature extracted from the first image, and the feature corresponds to one binary string, i.e., the fᵢ is a binary character string. The center of each visual word corresponds to one binary string. That is, the cᵢ is the binary string. Therefore, the Hamming distance from the feature fᵢ to the center cᵢ of the ith visual word may be calculated. The Hamming distance represents the number of different corresponding bits of two words (with the same length). In other words, the Hamming distance is the number of characters to be replaced when one character string is converted into another character string. For example, the Hamming distance between 1011101 and 1001001 is 2. In some embodiments, the weight of each visual word in the vocabulary tree is negatively correlated with the number of features included in the corresponding node. In some embodiments, if the Wᵢ is not 0, an index of the corresponding image is added to the ith visual word, and the index is configured to accelerate the retrieval of the image.

In some embodiments, the operation that the corresponding target weight of the target visual word in the first image is calculated according to the features extracted from the first image, the weight of the target visual word and the clustering center corresponding to the target visual word may include that: the features extracted from the first image are classified by using the vocabulary tree to obtain intermediate features classified to a target leaf node; and the corresponding target weight of the target visual word in the first image is calculated according to the intermediate features, the weight of the target visual word and the clustering center corresponding to the target visual word. The target leaf node corresponds to the target visual word. As can be seen from the formula (1), the target weight is a sum of weight parameters corresponding to the features included in the intermediate features. For example, the weight parameter corresponding to the feature fᵢ is:

$${W}_{iweight} * [ 1 - \frac{D i s ( {f}_{i} * {c}_{i} )}{256} ] .$$

The intermediate features may include a first feature and a second feature. The Hamming distance between the first feature and the clustering center serves as a first distance, and the Hamming distance between the second feature and the clustering center serves as a second distance. If the first distance is different from the second distance, the first weight parameter corresponding to the first feature and the second weight parameter corresponding to the second feature vary from each other.

In the implementation, the word vector is calculated by using a residual weighting manner. In view of differences of features fallen into the same visual word, the discrimination is increased, such that the access to a Term frequency-Inverse Document Frequency (TF-IDF) frame is very easy, and thus the speed for image retrieval and feature matching can be improved.

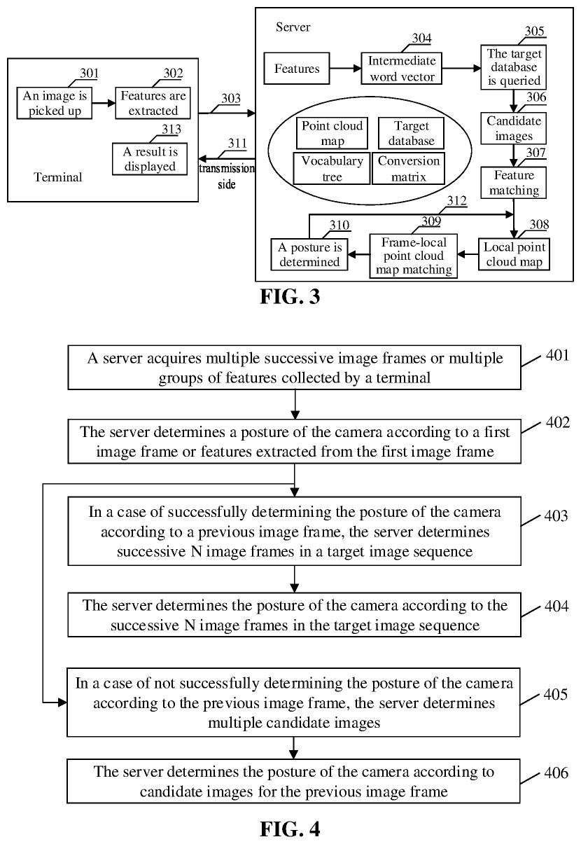

Hereinafter, the descriptions are made to the specific example of localization based on a single image. FIG. 3 illustrates another method for visual localization provided by an embodiment of the present disclosure. The method may include the following steps.

In 301, a terminal photographs a target image.

The terminal may be a mobile phone and other devices having a photographing function and/or shooting function.

In 302, the terminal extracts ORB features of the target image by using an ORB algorithm.

In some embodiments, the terminal extracts the features of the target image by using other feature extraction manners.

In 303, the terminal transmits the ORB features extracted from the target image and internal parameters of a camera to a server.

Step 302 to step 303 may be replaced as: the terminal transmits the target image and the internal parameters of the camera to the server, such that the server may extract the ORB features of the image, thereby reducing the computational burden of the terminal. In actual applications, the user may start a target application on the terminal, collect the target image through the target application by use of the camera, and transmit the target image to the server. The internal parameters of the camera may also be internal parameters of a camera of the terminal.

In 304, the server converts the ORB features into a intermediate word vector.

The manner that the server converts the ORB features into the intermediate word vector is the same as the manner for converting the features extracted from the first image into the target word vector by using the vocabulary tree in the foregoing embodiment, and is no longer elaborated herein.

In 305, the server determines, according to the intermediate word vector, top H images most similar to the target image in each image sequence, and obtains similarity scores corresponding to the top H images which have the highest similarity scores with the target image in each image sequence.

Each image sequence is included in the image library. Each image sequence is configured to construct a sub-point cloud map, and these sub-point cloud maps form a point cloud map corresponding to the to-be-localized scenario. Step 305 is to query top H images most similar to the target image in each image sequence of the image library. The H is an integer greater than 1, for example, the H is 10. Each image sequence may be obtained by collecting one region or multiple regions in the to-be-localized scenario. The server calculates the similarity score between each image in the image sequence and the target image according to the intermediate word vector. The formula for the similarity score may be as follows:

$$s ( v 1 , v 2 ) = 1 - \frac{1}{2} \vert \frac{v 1}{\vert v 1 \vert} - \frac{v 2}{\vert v 2 \vert} \vert . \qquad ( 2 )$$

Where, the s(v1, v2) denotes the similarity score between the visual word vector v1 and the visual word vector v2). The visual word vector v1 may be a word vector calculated by use of the formula (1) according to the ORB features extracted from the target image; and the visual word vector v2) may be a word vector calculated by the use of the formula (1) according to the ORB features extracted from any image in the image library. Supposing that the vocabulary tree includes L leaf nodes and each leaf node corresponds to one visual word, v1=[W₁W₂ . . . W_{L}], where, the W_{L} denotes a corresponding weight of an Lth visual word in the target image, and the L is an integer greater than 1. It may be understood that the visual word vector v1 and the visual word vector v2) have the same dimensionality. The server may store the visual word vector (corresponding to the above reference word vector) corresponding to each image in the image library. The visual word vector corresponding to each image is calculated by use of the formula (1) according to the features extracted from the image. It may be understood that the server only needs to calculate the visual word vector corresponding to the target image rather than to calculate visual word vectors corresponding to images included in each image sequence in the image library.

In some embodiments, the server only queries images sharing the visual word with the intermediate word vector, i.e., only compares the similarities according to image indexes in leaf nodes corresponding to non-zero items in the intermediate word vector. That is, images corresponding to at least one same visual word with the target image in the image library are determined to obtain multiple primary images; and top H frames most similar to the target image in the multiple primary images are queried according to the intermediate word vector. For example, if the corresponding weight of the ith visual word in the target image and the weight of some primary image are not 0, both the target image and the primary image correspond to the ith visual word.

In 306, the server takes out, according to a sequence of the similarity scores corresponding to the top H images and having the highest similarities with the target image in each sequence from high to low, multiple images having higher similarity scores with the target image to serve as candidate images.

In some embodiments, the image library includes F image sequences, and top 20% of images having the highest similarity scores with the target image in (F*H) images are taken out to serve as the candidate images. The (F*H) images include the top H images having the highest similarity scores with the target image in each image sequence. If the number of top 20% of images is smaller than 10, top 10 images are taken directly. Step 306 is the operation of screening the candidate images.

In 307, the serve performs feature matching on each image in the candidate images and the target image, and determines top G images having the largest number of matching features.

The G is an integer greater than 1, for example, the G is 5. In some embodiments, the features of the target image are first classified to some node on the Lth layer one by one according to the vocabulary tree, and the classification manner is to select, layer by layer, clustering center points (nodes in the tree) having the shortest current feature distances (Hamming distance) from the root node; and each classified feature only matches with the feature of which the feature index is provided in the corresponding node and the belonging image is the candidate image. In this way, the feature matching may be accelerated. Step 307 is the process in which each image in the candidate images is subjected to the feature matching with the target image. Hence, step 307 may be viewed as the process for the feature matching on two images.

In 308, the server acquires (2K+1) successive images from a reference image sequence.

The images in the reference image sequence are arranged according to a collected chronological order. The reference image sequence includes any image in the top G images, and the (2K+1) images (corresponding to a local point cloud map) include the any image, previous K images of the any image and rear K images of the any image. Step 308 is the operation for determining the local point cloud map.

In 309, the server determines multiple features matching with the features extracted from the target image from features extracted from the (2K+1) images.

The (2K+1) successive images in the reference image sequence correspond to one local point cloud map. Hence, step 309 may be viewed as the matching operation between the target image and the local point cloud map, i.e., the matching of the frame-local point cloud map in FIG. 3. In some embodiments, the extracted features having the corresponding similarity scores are first classified by using the vocabulary tree, and then the same processing is performed on the features extracted from the target image; and the considerations are only given to the matching between the features of the two parts which are fallen into the same node, such that the feature matching may be accelerated. In the two parts, one part is the target image, and the other part is the (2K+1) images.

In 310, the server determines a posture of the camera according to multiple features, spatial coordinates of the multiple features in the point cloud map and the internal parameters of the camera.

Step 310 is similar to step 203 in FIG. 2, and is no longer elaborated. Step 310 is executed in the server. In a case where the posture of the camera is not successfully determined, another image in the top G images is used to re-execute step 308 to step 310, till the posture of the camera is successfully determined. For example, (2K+1) images are first determined according to the first image in the top G images, and then the (2K+1) images are used to determine the posture of the camera. In a case where the posture of the camera is not successfully determined, new (2K+1) images are determined according to the second image in the top G images, and then the new (2K+1) images are used to determine the posture of the camera; and the above operation is repeated, till the posture of the camera is successfully determined.

In 311, the server sends position information of the camera to the terminal in a case of successfully determining the posture of the camera.

The position information may include a 3D position of the camera and a direction of the camera. In the case of successfully determining the posture of the camera, the server may determine the 3D position of the camera according to a conversion matrix and the posture of the camera, and generate the position information.

In 312, the server executes step 308 in case of not successfully determining the posture of the camera.

The server determines (2K+1) successive images according to one image in the top G images whenever executing step 308. It is to be understood that the determined (2K+1) successive images are different whenever the server execute step 308.

In 313, the terminal displays a position of the camera in an electronic map.

In some embodiments, the terminal displays the position and direction of the camera in the electronic map. It may be understood that the camera (i.e., camera) is mounted on the terminal, and the position of the camera is the position of the terminal. The user may accurately and quickly determine the own position and direction according to the position and direction of the camera.

In the embodiment of the present disclosure, the terminal and the server works cooperatively. The terminal collects the images and extracts the features, and the server takes the charge of localization and sends the localization results (i.e., position information) to the terminal; and by only sending one image to the server with the terminal, the user may accurately determine the own position.

FIG. 3 only describes the specific example of the localization based on the single image. In actual applications, the server may also perform the localization according to features of multiple successive images or multiple successive image frames sent by the terminal. Hereinafter, the descriptions are made to the specific example of localization based on multiple successive image frames. FIG. 4 illustrates another method for visual localization provided by an embodiment of the present disclosure. As shown in FIG. 4, the method may include the following steps.

In 401, a server acquires multiple successive image frames or multiple groups of features collected by a terminal.

Each group of features may be features extracted from one image frame, and the multiple groups of features sequentially are features extracted from multiple successive image frames. The multiple successive image frames are sequentially arranged according to a collected chronological order.

In 402, the server determines a posture of the camera according to a first image frame or features extracted from the first image frame.

The first image frame is a first image frame in the multiple successive image frames. Step 402 corresponds to the method for localizing based on the single image in FIG. 3. In other words, the server may determine the posture of the camera by using the method in FIG. 3 and the first image frame. The localization with the first image frame in the multiple successive image frames is the same as the localization based on the single image, That is, the first frame of localization in the multiple successive frames of localization is identical to the single localization. If the localization is successful, the successive frames of localization are performed; and if the localization is failed, the single localization is continued.

In 403, in a case of successfully determining the posture of the camera according to a previous image frame, the server determines successive N image frames in a target image sequence.

The case of successfully determining the posture of the camera according to the previous image frame refers to that the server executes step 402 to successfully determine the posture of the camera. The target image sequence is an image sequence to which features of the previous image frame for successfully determining the posture of the camera belong. For example, the server uses previous K images of some image in the target image sequence, the image and rear K images of the image to perform feature matching with the previous image frame, and successfully localizes the posture of the camera by using matching feature points; and the server acquires previous 30 images of the image in the target image sequence, the image and previous 30 images of the image, i.e., the successive N image frames.

In 404, the server determines the posture of the camera according to the successive N image frames in the target image sequence.

Step 404 corresponds to step 308 to step 310 in FIG. 3.

In 405, in a case of not successfully determining the posture of the camera according to the previous image frame, the server determines multiple candidate images.

The multiple candidate images are candidate images determined by the server according to the previous image frame. That is, in the case of not successfully determining the posture of the camera according to the previous image frame, the server may use the candidate images for the previous frame as candidate images for the current image frame. Therefore, the steps for image retrieval may be reduced, and the time is saved.

In 406, the server determines the posture of the camera according to candidate images for the previous image frame.

Step 406 corresponds to step 307 to step 310 in FIG. 3.

Upon the entry to the successive frames of localization, the server mainly uses priori knowledge for successfully localizing the previous frame to deduce that the image matching with the current frame has a big probability to be neighboring to the previously and successfully localized image. In this way, a window may be created nearby the image that is previously and successfully localized, and the priority is given to those image frames fallen into the window. The window may be 61 frames at most, with 30 frames in front and back; and any window less than 30 frames may be cut off. If the localization is successful, the window is passed down; and if the localization is not successful, the localization is performed according to single-frame candidate images. In the embodiment of the present disclosure, a successive-frame sliding window mechanism is used; and with coherent information on time sequence, the computational burden is effectively reduced, and the success rate for localization may be improved.

In the embodiment of the present disclosure, when performing the successive frames of localizations, the server may use the priori knowledge for successfully localizing the previous frame to accelerate the subsequent localization operation.

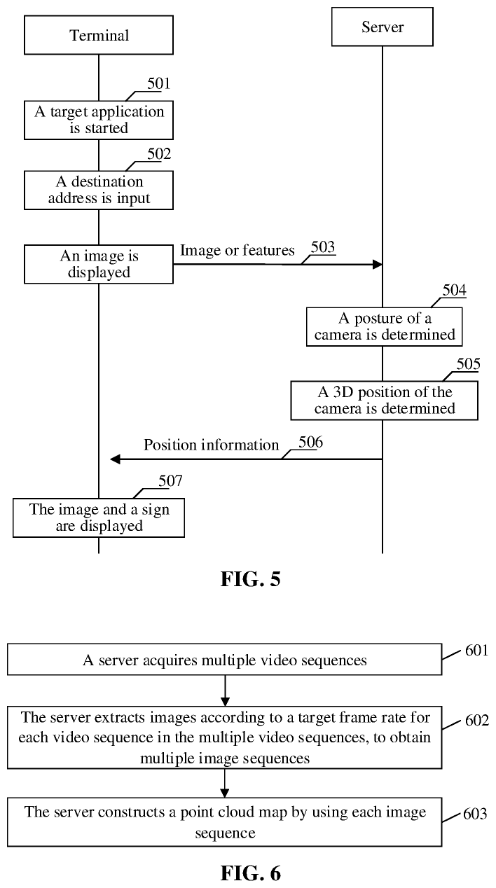

FIG. 4 describes the successive frames of localization; and an application embodiment on the successive frames of localization is illustrated below. FIG. 5 illustrates a localization navigating method provided by an embodiment of the present disclosure. As shown in FIG. 5, the method may include the following steps.

In 501, a terminal starts a target application.

The target application is an application specifically developed for accurate indoor localization. In actual applications, the user starts the target application by clicking the corresponding icon of the target application on the screen of the terminal.

In 502, the terminal receives, by a target interface, a destination address input by a user.

The target interface is an interface displayed on the screen of the terminal after the terminal starts the target application, i.e., an interface of the target application. The destination address may be the restaurant, coffee house, cinema, etc.

In 503, the terminal displays a current collected image, and transmits the collected image or features extracted from the collected image to a server.

Upon the reception of the destination address input by the user, the terminal may collect surrounding environmental images by a camera (i.e., a camera on the terminal) in real time or in approximately real time, and transmit the collected images to the server according to a fixed interval. In some embodiments, the terminal extracts features of the collected images, and transmits the extracted features to the server according to a fixed interval.

In 504, the server determines a posture of the camera according to the received image or features.

Step 504 corresponds to step 401 to step 406 in FIG. 4. In other words, the server determines the posture of the camera according to each received image frame or features of each image frame by use of the localization method in FIG. 4. It may be understood that the server may sequentially determine the posture of the camera according to an image sequence or feature sequence sent by the terminal, thereby determining the position of the camera. That is, the server may determine the posture of the camera in real time or approximately real time.

In 505, the server determines a 3D position of the camera according to a conversion matrix and the posture of the camera.

The conversion matrix is obtained by converting an angle and a position of the point cloud map, and aligning a contour of the point cloud map to an interior plan. Specifically, the rotation matrix R and the translation vector t are spliced into a 4*4

$${matrixT}^{′} = [ \begin{matrix}R & t \\ {0}^{T} & 1\end{matrix} ] ,$$

the conversion matrix Tᵢ is left multiplied with the matrix T′ to obtain a new matrix T=Tᵢ⁻¹*T′, the T is expressed as

$$T = [ \begin{matrix}{R}_{3 * 3}^{*} & {t}^{*} \\ {0}^{T} & 1\end{matrix} ] ,$$

and the t* is the final 3D position of the camera.

In 506, the server sends position information to the terminal.

The position information may include the 3D position of the camera, direction of the camera and sign information. The sign information indicates a route through which the user walks from the current position to the destination address. In some embodiments, the sign information only indicates the route within the target distance. The target distance is the furthest distance with the road in the current displayed image, and the target distance may be 10 m, 20 m, 50 m, etc. In the case of successfully determining the posture of the camera, the server may determine the 3D position of the camera according to the conversion matrix and the posture of the camera. Before executing step 506, the server may generate the sign information according to the position of the camera, the destination address and the electronic map.

In 507, the terminal displays the collected image in real time, and displays a sign that the user reaches the destination address.

For example, when the user gets lost or desires to visit some store in the shopping mall, the user starts the target application on the mobile phone, and inputs the destination address to be reached. The user holds up the mobile phone to collect images in front; and the mobile phone displays the collected images in real time, and displays signs, such as arrows, through which the user arrives at the destination address.

In the embodiment of the present disclosure, the server may accurately localize the position of the camera, and provides navigating information for the user; and the user may quickly reaches the target address according to the guidance.

In the foregoing embodiment, the server determines the posture of the camera by use of the point cloud map. Hereinafter, the descriptions are made to specific example on construction of the point cloud map. FIG. 6 illustrates a method for constructing a point cloud map provided by an embodiment of the present disclosure. As shown in FIG. 6, the method may include the following steps.

In 601, a server acquires multiple video sequences.

The user may divide the to-be-localized scenario into regions, and collect image sequences of multiple perspectives for each region; and image sequences in forward and backward directions are at least needed for each region. The multiple video sequences are video sequences obtained by photographing each region in the to-be-localized scenario from multiple perspectives.

In 602, the server extracts images according to a target frame rate for each video sequence in the multiple video sequences, to obtain multiple image sequences.

The server may obtain one image sequence by extracting one video sequence according to the target frame rate. The target frame rate may be 30 frames/second. Each image sequence is configured to construct a sub-point cloud map.

In 603, the server constructs a point cloud map by using each image sequence.

The server may construct one sub-point cloud map by using the SFM algorithm and each image sequence, and all sub-point cloud maps form the point cloud map.

In the embodiment of the present disclosure, the to-be-localized scenario is divided into multiple regions to construct the sub-point cloud maps. In this way, when some region in the to-be-localized scenario changes, only a video sequence of the region needs to be collected to construct the sub-point cloud map for the region, and the point cloud map for the whole to-be-localized scenario is unnecessarily constructed; and thus, the workload may be effectively reduced.

Upon acquiring multiple image sequences for constructing the point cloud map of the to-be-localized scenario, the server may store the multiple image sequences to the image library, and determine a visual word vector corresponding to each image in the multiple image sequences by using the vocabulary tree. The server may store the visual word vector corresponding to each image in the multiple image sequences. In some embodiments, the index of the corresponding image is added to each visual word included in the vocabulary tree. For example, in a case where the weight of the image corresponding to the visual word in the vocabulary tree in the image library is not 0, the index of the image is added to the visual word. In some embodiments, the server adds the index and feature index of the corresponding image to each visual word included in the vocabulary tree. The server may classify each feature of the image to the leaf node by using the vocabulary tree, and each leaf node corresponds to one visual word. For example, in a case where 100 features in the features extracted from each image in the image sequence falls into the leaf node, the feature index for the 100 features is adjusted in the visual word corresponding to the leaf node. The feature index indicates the 100 features.

Hereinafter, one specific example for localizing the target posture of the camera based on the image sequence and the first image is provided, and may include that: based on the image library, a sub-point cloud map established based on the first image sequence is determined, the sub-point cloud map including: a 3D coordinate and a 3D descriptor corresponding to the 3D coordinate; a 2D coordinate of the first image and a 2D descriptor corresponding to the 2D coordinate are determined; the 2D coordinate and the 2D descriptor match with the 3D coordinate and the 3D descriptor; and according to a conversion relationship between the successfully matching 2D coordinate and 2D descriptor and 3D coordinate and 3D descriptor, a first posture or a second posture is determined, and may be used to localizing the posture of the camera. The 3D descriptor may be description information of the 3D coordinate, and include: a coordinate neighboring to the 3D coordinate and/or attribute information of the neighboring coordinate. The 2D descriptor may be description information of the 2D coordinate. For example, the first posture or the second posture of the camera is determined by using the PnP algorithm and the conversion relationship.

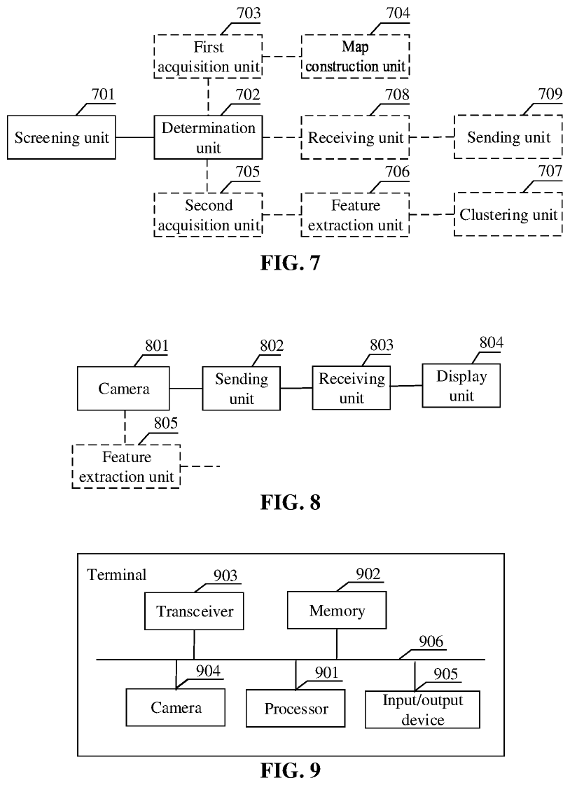

FIG. 7 illustrates a structural schematic diagram of an apparatus for visual localization provided by an embodiment of the present disclosure. As shown in FIG. 7, the visual localization apparatus may include: a screening unit 701, and a determination unit 702.

The screening unit 701 is configured to determine a first candidate image sequence from an image library, the image library being configured to construct an electronic map, image frames in the first candidate image sequence being sequentially arranged according to degrees of matching with a first image, and the first image being an image collected by a camera.

The screening unit 701 is further configured to adjust an order of the image frames in the first candidate image sequence according to a target window to obtain a second candidate image sequence, the target window being multiple successive image frames including a target image frame and determined from the image library, the target image frame being an image matching with a second image in the image library, and the second image being an image collected by the camera before the first image is collected.

The determination unit 702 is configured to determine, according to the second candidate image sequence, a target posture of the camera when the first image is collected.

In an implementation of some embodiments, the determination unit 702 is configured to determine a first posture of the camera according to a first image sequence and the first image, the first image sequence including multiple successive image frames neighboring to a first reference image frame in the image library, and the first reference image frame being included in the second candidate sequence; and

determine, in a case where it is determined that a position of the camera is successfully localized according to the first posture, the first posture as the target posture.

In an implementation of some embodiments, the determination unit 702 is configured to determine, in a case where it is determined that the position of the camera is not successfully localized according to the first posture, a second posture of the camera according to a second image sequence and the first image, the second image sequence including multiple successive image frames neighboring to a second reference image frame in the image library, and the second reference image frame being a next image frame or a previous image frame of the first reference image frame in the second candidate image sequence; and determine, in a case where it is determined that the position of the camera is successfully localized according to the second posture, the second posture as the target posture.

In an implementation of some embodiments, the determination unit 702 is configured to determine, from features extracted from each image in the first image sequence, F features matching with features extracted from the first image, the F being an integer greater than 0; and

determine the first posture according to the F features, spatial coordinates corresponding to the F features in a point cloud map and internal parameters of the camera, the point cloud map being an electronic map of a to-be-localized scenario, and the to-be-localized scenario being a scenario of the camera when the first image is collected.

In an implementation of some embodiments, the screening unit is configured to adjust, in the case where the image frames in the first candidate image sequence are sequentially arranged according to the degrees of matching with the first image from low to high, the image located in the target window in the first candidate image sequence to a last position of the first candidate image sequence; and

adjust, in the case where the image frames in the first candidate image sequence are sequentially arranged according to the degrees of matching with the first image from high to low, the image located in the target window in the first candidate image sequence to a most front position of the first candidate image sequence.

In an implementation of some embodiments, the screening unit 701 is configured to adjust, in a case where the image frames in the first candidate image sequence are sequentially arranged according to the degrees of matching with the first image from low to high, an image located in the target window in the first candidate image sequence to a last position of the first candidate image sequence; and adjust, in a case where the image frames in the first candidate image sequence are sequentially arranged according to the degrees of matching with the first image from high to low, an image located in the target window in the first candidate image sequence to a most front position of the first candidate image sequence.

In an implementation of some embodiments, the screening unit 701 is configured to determine images corresponding to at least one same visual word with the first image in the image library to obtain multiple primary images, any image in the image library corresponding to at least one visual word, and the first image corresponding to at least one visual word; and determine multiple candidate images of which corresponding visual word vectors have a highest similarity with the visual word vector of the first image in the multiple primary images.

In an implementation of some embodiments, the screening unit 701 is configured to determine top Q % of images of which corresponding visual word vectors have a highest similarity with the visual word vector of the first image in the multiple primary images to obtain the multiple candidate images, the Q being a real number greater than 0.

In an implementation of some embodiments, the screening unit 701 is configured to convert the features extracted from the first image into a target word vector by using a vocabulary tree, the vocabulary tree being obtained by clustering features extracted from training images collected from the to-be-localized scenario;

calculate a similarity between the target word vector and a visual word vector corresponding to each primary image in the multiple primary images, the visual word vector corresponding to any primary image in the multiple primary images being a visual word vector obtained, by using the vocabulary tree, from features extracted from the primary image; and

determine multiple candidate images of which corresponding visual word vectors have a highest similarity with the target visual word vector in the multiple primary images.

In an implementation of some embodiments, each leaf node in the vocabulary tree corresponds to one visual word, and nodes on a last layer of the vocabulary tree are leaf nodes; and

the screening unit 701 is configured to calculate corresponding weights of visual words corresponding to leaf nodes in the vocabulary tree in the first image; and combine the corresponding weights of the visual words corresponding to the leaf nodes in the first image into a vector to obtain the target word vector.

In an implementation of some embodiments, each node in the vocabulary tree corresponds to one clustering center; and

the screening unit 701 is configured to classify, by using the vocabulary tree, the features extracted from the first image to obtain intermediate features classified to a target leaf node, the target leaf node being any leaf node in the vocabulary tree, and the target leaf node corresponding to a target visual word; and

calculate a corresponding target weight of the target visual word in the first image according to the intermediate features, a weight of the target visual word and a clustering center corresponding to the target visual word, the target weight being positively correlated with the weight of the target visual word, and the weight of the target visual word being determined according to the number of corresponding features of the target visual word when the vocabulary tree is generated.

In an implementation of some embodiments, the screening unit 701 is configured to classify a third feature extracted from the first image to a leaf node according to the vocabulary tree, the vocabulary tree being obtained by clustering features extracted from images collected in the to-be-localized scenario, nodes on a last layer of the vocabulary tree being leaf nodes, and each leaf node including multiple features;

perform the feature matching on the third feature and a fourth feature in each leaf node, to obtain the fourth feature matching with the third feature in each leaf node, the fourth feature being a feature extracted from a target candidate image, and the target candidate image being included in any image in the first candidate image sequence; and

obtain, according to the fourth feature matching with the third feature in each leaf node, the number of features matching with the first image in the target candidate image.

In an implementation of some embodiments, the determination unit 702 is further configured to determine 3D position of the camera according a conversion matrix and the first posture, the conversion matrix being obtained by converting an angle and a position of the point cloud map, and aligning a contour of the point cloud map to an interior plan.

In an implementation of some embodiments, the determination unit 702 is configured to determine that position relationships for L pairs of feature points meet the first posture, each pair of feature points including one feature point extracted from the first image and the other feature point extracted from an image in the first image sequence, and the L being an integer greater than 1.

In an implementation of some embodiments, the apparatus may further include: a first acquisition unit 703, and a map construction unit 704.

The first acquisition unit 703 is configured to acquire multiple image sequences, each image sequence being obtained by collecting one region or multiple regions in a to-be-localized scenario.

The map construction unit 704 is configured to construct the point cloud map according to the multiple image sequences, any image sequence in the multiple image sequences being configured to construct a sub-point cloud map for one or more regions, and the point cloud map including a first electronic map and a second electronic map.

In an implementation of some embodiments, the apparatus may further include: a second acquisition unit 705, a feature extraction unit 706 and a clustering unit 707.

The second acquisition unit 705 is configured to acquire multiple training images obtained by photographing the to-be-localized scenario.

The feature extraction unit 706 is configured to perform feature extraction on the multiple training images to obtain a training feature set.

The clustering unit 707 is configured to cluster features in the training feature set for multiple times to obtain the vocabulary tree. The second acquisition unit 705 and the first acquisition unit 703 may be the same unit, and may also be different units.

In an implementation of some embodiments, the visual localization apparatus is a server, and the apparatus may further include: a receiving unit 708.

The receiving unit 708 is configured to receive the first image from the target device, the target device being provided with the camera.

In an implementation of some embodiments, the apparatus may further include: a sending unit 709.

The sending unit 709 is configured to send position information of the camera to the target device.

FIG. 8 illustrates a structural schematic diagram of a terminal provided by an embodiment of the present disclosure. As shown in FIG. 8, the terminal may include: a camera 801, a sending unit 802, a receiving unit 803 and a display unit 804.

The camera 801 is configured to collect a target image.

The sending unit 802 is configured to send target information to a server, the target information including the target image or a feature sequence extracted from the target image, and internal parameters of the camera.

The receiving unit 803 is configured to receive position information, wherein the position information is configured to indicate a position and a direction of the camera; the position information is information of a position, determined by the server according to a second candidate image sequence, of the camera when the target image is collected; and the second candidate image sequence is obtained by the server through adjusting an order of image frames in a first candidate image sequence according to a target window, the target window is multiple successive image frames including a target image frame and determined from an image library, the image library is configured to construct an electronic map, the target image frame is an image matching with a second image in the image library, the second image is an image collected by the camera before the first image is collected, and the image frames in the first candidate image sequence are sequentially arranged according to degrees of matching with the first image.

The display unit 804 is configured to display an electronic map, the electronic map including the position and the direction of the camera.

In some embodiments, the terminal may further include: a feature extraction unit 805, configured to extract the features of the target image.

The position information may include a 3D position of the camera and a direction of the camera. The camera 801 may be specifically configured to execute the method in step 301 and equivalent methods; the feature extraction unit 805 may be specifically configured to execute the method in step 302 and equivalent methods; the sending unit 802 may be specifically configured to execute the method in step 303 and equivalent methods; and the display unit 804 may be specifically configured to execute the method in step 313 and step 507 and equivalent methods. It may be understood that the terminal in FIG. 8 may implement the operations executed by the terminal in FIG. 3 and FIG. 5.

It is to be understood that division of the units in the above visual localization apparatus and terminal is only logic function division, and the units may be completely or partially integrated to a physical entity and may also be physically separated in actual implementation. For example, the above units may be separate processing elements, and may also be integrated to the same chip for implementation. In addition, the units may also be stored in a storage element of a controller in the form of a program code, and called in some processing unit in a memory to execute the functions of the units. Besides, the units may be integrated together, and may also be independently implemented. The processing element herein may be an integrated circuit chip, and has a signal processing capability. During implementation, each step of the method or each unit may be completed by means of an instruction in the form of an integrated logic circuit of hardware in the processing element or software. The processing element may be a universal processor such as a Central Processing Unit (CPU), and may further be one or more integrated circuits configured to implement the above method, such as one or more Application-Specific Integrated Circuits (ASICs), or, one or more Digital Signal Processors (DSPs), or, one or more Field-Programmable Gate Arrays (FPGAs).

FIG. 9 illustrates a structural schematic diagram of another terminal provided by an embodiment of the present disclosure. The terminal shown in FIG. 9 in the embodiment may include: one or more processors 901, a memory 902, a transceiver 903, a camera 904 and an input/output device 905. The processor 901, the memory 902, the transceiver 903, the camera 904 and the input/output device 905 are connected by a bus 906. The memory 902 is configured to store an instruction, and the processor 901 is configured to execute the instruction stored in the memory 902. The transceiver 903 is configured to receive and send data. The camera 904 is configured to collect an image. The processor 901 is configured to control the transceiver 903, the camera 904 and the input/output device 905 to implement the operations executed by the terminal in FIG. 3 and FIG. 5.

It is to be noted that, in the embodiment of the disclosure, the processor 901 may be a CPU, and the processor may further be another universal processor, a DSP, an ASIC, an FPGA or another programmable logic device, separate gate or transistor logic device, separate hardware component and the like. The universal processor may be a microprocessor or the processor may also be any conventional processor and the like.

The memory 902 may include a Read-Only Memory (ROM) and a Random Access Memory (AM) and provides an instruction and data for the processor 901. A part of the memory 902 may further include a nonvolatile random access memory. For example, the memory 902 may further store information on a device type.

During specific implementation, the processor 901, the memory 902, the transceiver 903, the camera 904 and the input/output device 905 described in the embodiment of the present disclosure may execute the implementation of the terminal in the above any embodiment, which is no longer elaborated herein. Specifically, the transceiver 903 may implement the functions of the sending unit 802 and the receiving unit 803. The processor 901 may implement the function of the feature extraction unit 805. The input/output device 905 is configured to implement the function of the display unit 804, and the input/output device 905 may be a display screen.

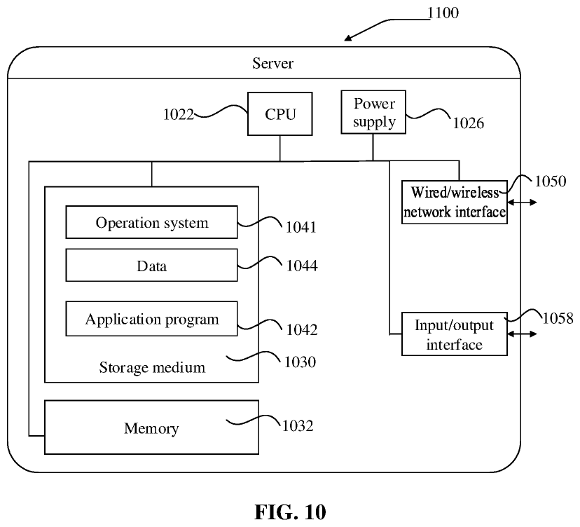

FIG. 10 is a structural schematic diagram of a server provided by an embodiment of the present disclosure. The server 1100 may have a big difference due to different configurations or performances, and may include one or more CPUs 1022 (one or more processors) and memories 1032, and one or more storage media 1030 on which application programs 1042 or data 1044 are stored (such as one or more massive storage devices). The memory 1032 and the storage medium 1030 may be for temporary storage or a persistent storage. The program stored in the storage medium 1030 may include one or more modules (not shown in the figure); and each module may include a series of instruction operations in the server. Still further, the CPU 1022 may be configured to communicate with the storage medium 1030, and execute, on the server 1100, the series of instruction operations in the storage medium 1030.

The server 1100 may further include one or more power supplies 1026, one or more wired or wireless network interfaces 1050, one or more input/output interfaces 1058, and/or, one or more operation systems 1041, such as Windows Server™, Mac OS X™, Unix™k Linux™ and FreeBSD™.

The steps executed by the server in the above embodiment may be based on the structure of the server shown in FIG. 10. Specifically, the input/output interface 1058 may implement the functions of the receiving unit 708 and the sending unit 709. The CPU 1022 may implement the functions of the screening unit 701, the determination unit 702, the first acquisition unit 703, the map construction unit 704, the second acquisition unit 705, the feature extraction unit 706 and the clustering unit 707.

The embodiments of the present disclosure provide a computer-readable storage medium, which stores a computer program; and the computer program is executed by a processor to implement that: a first candidate image sequence is determined from an image library, the image library being configured to construct an electronic map, image frames in the first candidate image sequence being sequentially arranged according to degrees of matching with a first image, and the first image being an image collected by a camera; an order of the image frames in the first candidate image sequence is adjusted according to a target window to obtain a second candidate image sequence, the target window being multiple successive image frames including a target image frame and determined from the image library, the target image frame being an image matching with a second image in the image library, and the second image being an image collected by the camera before the first image is collected; and a target posture of the camera when the first image is collected is determined according to the second candidate image sequence.

The embodiments of the present disclosure provide another computer-readable storage medium, which stores a computer program; and the computer program is executed by a processor to implement that: a target image is collected by a camera; target information is sent to a server, the target information including the target image or a feature sequence extracted from the target image, and internal parameters of the camera; position information is received, wherein the position information is configured to indicate a position and a direction of the camera; the position information is information of a position, determined by the server according to a second candidate image sequence, of the camera when the target image is collected; and the second candidate image sequence is obtained by the server through adjusting an order of image frames in a first candidate image sequence according to a target window, the target window is multiple successive image frames including a target image frame and determined from an image library, the image library is configured to construct an electronic map, the target image frame is an image matching with a second image in the image library, the second image is an image collected by the camera before the first image is collected, and the image frames in the first candidate image sequence are sequentially arranged according to degrees of matching with the first image; and an electronic map is displayed, the electronic map including the position and the direction of the camera. The above is only the specific implementation of the present disclosure and not intended to limit the scope of protection of the present disclosure. Any variations or replacements apparent to those skilled in the art within the technical scope disclosed by the present disclosure shall fall within the scope of protection of the present disclosure. Therefore, the scope of protection of the present disclosure should be subjected to the scope of protection of the claims.

1. A method for visual localization, comprising:
determining a first candidate image sequence from an image library, image frames in the first candidate image sequence being sequentially arranged according to degrees of matching with a first image, and the first image being an image collected by a camera;
adjusting an order of the image frames in the first candidate image sequence according to a target window to obtain a second candidate image sequence, the target window being multiple successive image frames comprising a target image frame and determined from the image library, the target image frame being an image matching with a second image in the image library, and the second image being an image collected by the camera before the first image is collected; and
determining, according to the second candidate image sequence, a target posture of the camera when the first image is collected.

2. The method of claim 1, wherein determining, according to the second candidate image sequence, the target posture of the camera when the first image is collected comprises:
determining a first posture of the camera according to a first image sequence and the first image, the first image sequence comprising multiple successive image frames neighboring to a first reference image frame in the image library, and the first reference image frame being comprised in the second candidate image sequence; and
in a case where a position of the camera is successfully localized according to the first posture, determining the first posture as the target posture.

3. The method of claim 2, wherein after determining the first posture according to the first image sequence and the first image, the method further comprises:
in a case where the position of the camera is not successfully localized according to the first posture, determining a second posture of the camera according to a second image sequence and the first image, the second image sequence comprising multiple successive image frames neighboring to a second reference image frame in the image library, and the second reference image frame being a next image frame or a previous image frame of the first reference image frame in the second candidate image sequence; and
in a case where the position of the camera is successfully localized according to the second posture, determining the second posture as the target posture.

4. The method of claim 2, wherein determining the first posture according to the first image sequence and the first image comprises:
from features extracted from each image in the first image sequence, determining F features matching with features extracted from the first image, the F being an integer greater than 0; and
determining the first posture according to the F features, spatial coordinates corresponding to the F features in a point cloud map and internal parameters of the camera, the point cloud map being an electronic map of a to-be-localized scenario, and the to-be-localized scenario being a scenario of the camera when the first image is collected.

5. The method of claim 1, wherein adjusting the order of the image frames in the first candidate image sequence according to the target window to obtain the second candidate image sequence comprises:
in a case where the image frames in the first candidate image sequence are sequentially arranged according to the degrees of matching with the first image from low to high, adjusting an image located in the target window in the first candidate image sequence to a last position of the first candidate image sequence; and
in a case where the image frames in the first candidate image sequence are sequentially arranged according to the degrees of matching with the first image from high to low, adjusting an image located in the target window in the first candidate image sequence to a most front position of the first candidate image sequence.

6. The method of claim 5, wherein determining the first candidate image sequence from the image library comprises:
determining multiple candidate images of which corresponding visual word vectors have a highest similarity with a visual word vector corresponding to the first image in the image library, any image in the image library corresponding to one visual word vector, and images in the image library being configured to construct an electronic map of a to-be-localized scenario of a target device when the first image is collected; and
performing feature matching on the multiple candidate images with the first image to obtain the number of features matching with the first image in each candidate image; and
acquiring M images having the largest number of features matching with the first image from the multiple candidate images to obtain the first candidate image sequence.

7. The method of claim 6, wherein determining the multiple candidate images of which the corresponding visual word vectors have the highest similarity with the visual word vector of the first image in the image library comprises:
determining images corresponding to at least one same visual word with the first image in the image library to obtain multiple primary images, any image in the image library corresponding to at least one visual word, and the first image corresponding to at least one visual word; and
determining multiple candidate images of which corresponding visual word vectors have a highest similarity with the visual word vector of the first image in the multiple primary images.

8. The method of claim 7, wherein determining the multiple candidate images of which the corresponding visual word vectors have the highest similarity with the visual word vector of the first image in the multiple primary images comprises:
determining top Q % of images of which corresponding visual word vectors have a highest similarity with the visual word vector of the first image in the multiple primary images to obtain the multiple candidate images, the Q being a real number greater than 0.

9. The method of claim 7, wherein determining the multiple candidate images of which the corresponding visual word vectors have the highest similarity with the visual word vector of the first image in the multiple primary images comprises:
converting the features extracted from the first image into a target word vector by using a vocabulary tree, the vocabulary tree being obtained by clustering features extracted from training images collected from the to-be-localized scenario;
calculating a similarity between the target word vector and a visual word vector corresponding to each primary image in the multiple primary images, the visual word vector corresponding to any primary image in the multiple primary images being a visual word vector obtained, by using the vocabulary tree, from features extracted from the primary image; and
determining multiple candidate images of which corresponding visual word vectors have a highest similarity with the target word vector in the multiple primary images,
wherein each leaf node in the vocabulary tree corresponds to one visual word, and nodes on a last layer of the vocabulary tree are leaf nodes; and converting the features extracted from the first image into the target word vector by using the vocabulary tree comprises:
calculating corresponding weights of visual words corresponding to leaf nodes in the vocabulary tree in the first image; and
combining the corresponding weights of the visual words corresponding to the leaf nodes in the first image into a vector to obtain the target word vector.

10. The method of claim 9 wherein each node in the vocabulary tree corresponds to one clustering center; and calculating the corresponding weights of the visual words in the vocabulary tree in the first image comprises:
classifying, by using the vocabulary tree, the features extracted from the first image to obtain intermediate features classified to a target leaf node, the target leaf node being any leaf node in the vocabulary tree, and the target leaf node corresponding to a target visual word; and
calculating a corresponding target weight of the target visual word in the first image according to the intermediate features, a weight of the target visual word and a clustering center corresponding to the target visual word, the target weight being positively correlated with the weight of the target visual word, and the weight of the target visual word being determined according to the number of corresponding features of the target visual word when the vocabulary tree is generated,
wherein the intermediate features comprise at least one sub-feature; the target weight is a sum of weight parameters corresponding to sub-features comprised in the intermediate features; and the weight parameters corresponding to the sub-features are negatively correlated with a feature distance, and the feature distance is a Hamming distance between each sub-feature and a corresponding clustering center.

11. The method of claim 6, wherein performing feature matching on the multiple candidate images with the first image to obtain the number of features matching with the first image in each candidate image comprises:
according to a vocabulary tree, classifying a third feature extracted from the first image to a leaf node, the vocabulary tree being obtained by clustering features extracted from images collected in the to-be-localized scenario, nodes on a last layer of the vocabulary tree being leaf nodes, and each leaf node comprising multiple features;
performing the feature matching on the third feature and a fourth feature in each leaf node, to obtain the fourth feature matching with the third feature in each leaf node, the fourth feature being a feature extracted from a target candidate image, and the target candidate image being comprised in any image in the first candidate image sequence; and
according to the fourth feature matching with the third feature in each leaf node, obtaining the number of features matching with the first image in the target candidate image,
and/or wherein after determining a first posture according to the F features, spatial coordinates corresponding to the F features in a point cloud map and internal parameters of the camera, the method further comprises:
determining a Three-Dimensional (3D) position of the camera according a conversion matrix and the first posture, the conversion matrix being obtained by converting an angle and a position of the point cloud map, and aligning a contour of the point cloud map to an interior plan.

12. The method of claim 2, wherein the case where the position of the camera is successfully localized by the first posture comprises: determining that position relationships for L pairs of feature points meet the first posture, each pair of feature points comprising one feature point extracted from the first image and the other feature point extracted from an image in the first image sequence, and the L being an integer greater than 1.

13. The method of claim 2, before determining the first posture of the camera according to the first image sequence and the first image, further comprising:
acquiring multiple image sequences, each image sequence being obtained by collecting one region or multiple regions in a to-be-localized scenario; and
constructing a point cloud map according to the multiple image sequences, any image sequence in the multiple image sequences being configured to construct a sub-point cloud map for one or more regions, and the point cloud map comprising a first electronic map and a second electronic map.

14. The method of claim 9, wherein before converting the features extracted from the first image into the target word vector by using the vocabulary tree, the method further comprises:
acquiring multiple training images obtained by photographing the to-be-localized scenario;
performing feature extraction on the multiple training images to obtain a training feature set; and
clustering features in the training feature set for multiple times to obtain the vocabulary tree.

15. A method for visual localization, comprising:
collecting a target image by a camera;
sending target information to a server, the target information comprising the target image or a feature sequence extracted from the target image, and internal parameters of the camera;
receiving position information, wherein the position information is configured to indicate a position and a direction of the camera; the position information is information of a position, determined by the server according to a second candidate image sequence, of the camera when the target image is collected; and the second candidate image sequence is obtained by the server through adjusting an order of image frames in a first candidate image sequence according to a target window, the target window is multiple successive image frames comprising a target image frame and determined from an image library, the image library is configured to construct an electronic map, the target image frame is an image matching with a second image in the image library, the second image is an image collected by the camera before a first image is collected, and the image frames in the first candidate image sequence are sequentially arranged according to degrees of matching with the first image; and
displaying an electronic map, the electronic map comprising the position and the direction of the camera.

16. A visual localization system, comprising: a server and a terminal device, wherein the server executes the method of claim 1, and the terminal device is configured to execute a method for visual localization, the method comprising:
collecting a target image by a camera;
sending target information to a server, the target information comprising the target image or a feature sequence extracted from the target image, and internal parameters of the camera;
receiving position information, wherein the position information is configured to indicate a position and a direction of the camera; the position information is information of a position, determined by the server according to a second candidate image sequence, of the camera when the target image is collected; and the second candidate image sequence is obtained by the server through adjusting an order of image frames in a first candidate image sequence according to a target window, the target window is multiple successive image frames comprising a target image frame and determined from an image library, the image library is configured to construct an electronic map, the target image frame is an image matching with a second image in the image library, the second image is an image collected by the camera before the first image is collected, and the image frames in the first candidate image sequence are sequentially arranged according to degrees of matching with the first image; and
displaying an electronic map, the electronic map comprising the position and the direction of the camera.

17. An electronic device, comprising:
a memory, configured to store a program; and
a processor, configured to execute the program stored in the memory, wherein when the program is executed, the processor is configured to execute the method of claim 1.

18. A terminal device, comprising:
a camera, configured to collect a target image;
a transceiver, configured to send target information to a server, the target information comprising the target image or a feature sequence extracted from the target image, and internal parameters of the camera; receive position information, wherein the position information is configured to indicate a position and a direction of the camera; the position information is information of a position, determined by the server according to a second candidate image sequence, of the camera when the target image is collected; and the second candidate image sequence is obtained by the server through adjusting an order of image frames in a first candidate image sequence according to a target window, the target window is multiple successive image frames comprising a target image frame and determined from an image library, the image library is configured to construct an electronic map, the target image frame is an image matching with a second image in the image library, the second image is an image collected by the camera before a first image is collected, and the image frames in the first candidate image sequence are sequentially arranged according to degrees of matching with the first image; and
a display, configured to display an electronic map, the electronic map comprising the position and the direction of the camera.

19. A non-transitory computer-readable storage medium having stored a computer program, wherein the computer program comprises program instructions, and the program instructions are executed by a processor to cause the processor to execute the method of claim 1.

20. A non-transitory computer-readable storage medium having stored a computer program, wherein the computer program comprises program instructions, and the program instructions are executed by a processor to cause the processor to execute the method of claim 15.
